(19) United States
(12) Patent Application Publication
(10) Pub. No.: US 2026/0086849 A1
(43) Pub. Date: Mar. 26, 2026

(54) DYNAMIC ORDER CALCULATION OF SOFTWARE TASKS BASED ON DATA READ AND WRITE PROCESSES

(71) Applicant: SAP SE, Walldorf (DE)

(72) Inventors: Wulf Kruempelmann, Altlussheim (DE); Susanne Schott, Walldorf (DE)

(21) Appl. No.: 18/892,916

(22) Filed: Sep. 23, 2024

(51) Int. Cl. G06F 9/48

(52) U.S. Cl. CPC G06F 9/4881; G06F 9/485

(57) ABSTRACT

A parsing unit parses database calls from a first list of programs to generate a second list of programs specifying tables that are read or written by each program from the first list. A control unit determines, from the second list of programs, if any first programs do not read data written by other programs from the second list of programs. The control unit inserts the first programs at a beginning of a first table. Next, the control unit determines, if any programs still in the second list of programs only read data written by programs in the first table. These programs are inserted in the first table after the first programs. After this step has been performed multiple times, any programs remaining in the second list of programs are inserted at the end of the first table. Finally, programs from the first table are executed in order.

### TECHNICAL FIELD

The present disclosure generally relates to dynamically determining an order of software tasks in an enterprise resource planning system based on data read and write processes.

### BACKGROUND

An application can be hosted by a cloud platform such that the application can be remotely accessible to multiple tenants, for example, over the Internet. For example, the application can be available as a cloud-based service including, for example, a software as a service (SaaS) and/or the like. Many organizations rely on such cloud-based enterprise software applications including, for example, enterprise resource planning (ERP) software, customer relationship management (CRM) software, and/or the like. These enterprise software applications may provide a variety of functionalities including, for example, invoicing, procurement, payroll, time and attendance management, recruiting and onboarding, learning and development, performance and compensation, workforce planning, and/or the like. An ERP system includes software and technical configuration data for all business processes. In a complex ERP scenario, the setup of the system is performed by a set of software tasks, which perform setup of technical parameters, setup of support processes, and setup of communication scenarios. These setup tasks read and write data from database tables. Often the number of setup tasks can be in the hundreds or thousands, making the setup of the system a complex and time-consuming process.

### SUMMARY

In some implementations, a parsing unit parses database calls from a first list of programs to generate a second list of programs specifying tables that are read from or written to by each program from the first list. A control unit determines, from the second list of programs, if any first programs do not read data written by other programs from the second list of programs. The control unit inserts the first programs at a beginning of a first table. Next, the control unit determines, from the second list of programs, if any second programs only read data written by the first programs. The control unit inserts the second programs after the first programs in the first table. Then, the control unit determines, from the second list of programs, if any third programs only read data written by the second programs. The control unit inserts the third programs after the second programs in the first table. Next, the control unit inserts any fourth programs remaining in the second list of programs after the third programs in the first table. Finally, the control unit causes programs from the first table to be executed in an order based on the inserting so as to setup a computing system for operation. In an example, the computing system is an enterprise resource planning (ERP) system.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a logical diagram of an example of a system, in accordance with some example implementations of the current subject matter;

FIG. 2 illustrates a logical block diagram of a database system, in accordance with some example implementations of the current subject matter;

FIG. 3 illustrates a block diagram of a parser, in accordance with some example implementations of the current subject matter;

FIG. 4 illustrates a block diagram of a control unit, in accordance with some example implementations of the current subject matter;

FIG. 5 illustrates an example of a process for parsing a list of setup programs, in accordance with some example implementations of the current subject matter;

FIG. 6 illustrates an example of a process for determining an order to launch setup programs, in accordance with some example implementations of the current subject matter;

FIG. 7 illustrates an example of a process for executing a list of programs at system startup when one or more programs have circular dependencies, in accordance with some example implementations of the current subject matter;

FIG. 8A depicts an example of a system, in accordance with some example implementations of the current subject matter; and

FIG. 8B depicts another example of a system, in accordance with some example implementations of the current subject matter.

### DETAILED DESCRIPTION

An enterprise resource planning (ERP) system includes software and technical configuration data for all business processes. In complex ERP scenarios, the setup of the systems is performed by a set of software tasks, which perform a setup of technical parameters, setup of support processes and setup of communication scenarios. These setup tasks read and write data from database tables. These reads and writes create dependencies such that some tasks require the data generated by another task. This order information is currently not calculated but tested via trial and error. Accordingly, techniques for automatically determining the order for running setup tasks and executing the setup tasks according to the determined order are desired.

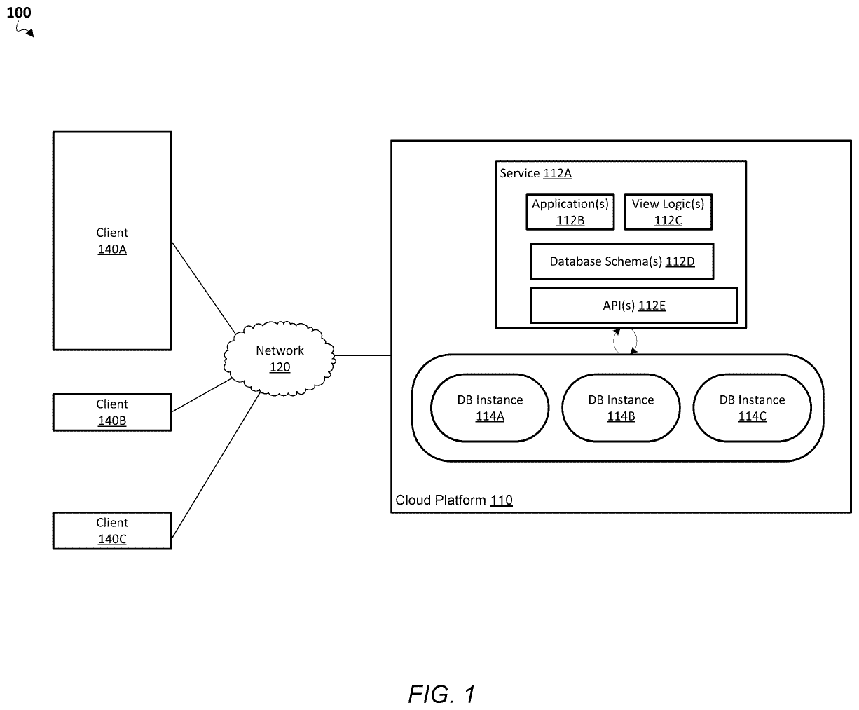

FIG. 1 depicts a diagram illustrating an example of a system 100 consistent with some implementations of the current subject matter. Referring to FIG. 1, the system 100 may include a cloud platform 110. The cloud platform 110 may provide resources that can be shared among a plurality of tenants. For example, the cloud platform 110 may be configured to provide a variety of services including, for example, software-as-a-service (SaaS), platform-as-a-service (PaaS), infrastructure as a service (IaaS), database as a service (DaaS), and/or the like, and these services can be accessed, via network 120, by one or more tenants of the cloud platform 110. Network 120 may be any wired and/or wireless network including, for example, a public land mobile network (PLMN), a wide area network (WAN), a local area network (LAN), a virtual local area network (VLAN), the Internet, and/or the like.

In the example of FIG. 1, the system 100 includes a first tenant 140A (labeled client), a second tenant 140B, and a third tenant 140C, although cloud platform 110 may have other quantities of tenants. The clients may each comprise a user device (e.g., a computer including an application such as a browser or other type of application). The user device may be a processor-based device including, for example, a smartphone, a tablet computer, a wearable apparatus, a virtual assistant, an Internet-of-Things (IoT) appliance, and/or the like. Each client may access, via network 120, at least one of the services at the cloud platform 110. In some implementations, each of the tenants 140A-C represents a separate tenant at the cloud platform 110, such that a tenant's data is not shared with other tenants (absent permission from a tenant). Alternatively, each of the tenants 140A-C may represent a single tenant at the cloud platform 110, such that the tenants do share a portion of the tenant's data, for example.

The cloud platform 110 may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources. In the case of a “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110 includes a service 112A, which is provided to the client 140A. This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client 140A). To illustrate further, client 140A may access the application 112B to view data and/or query data stored in a database instance 114A, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-C, also referred to more simply as databases) and the application layer, such as application 112B, which in this example is a multitenant application at the cloud platform 110.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database instance 114A may be accessed as a service at a cloud platform, which may be the same or different platform from cloud platform 110. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110. Although the database instances are depicted at the same cloud platform 110, one or more of the database instances may be hosted on another or separate platform (e.g., on-premise) and/or another cloud platform.

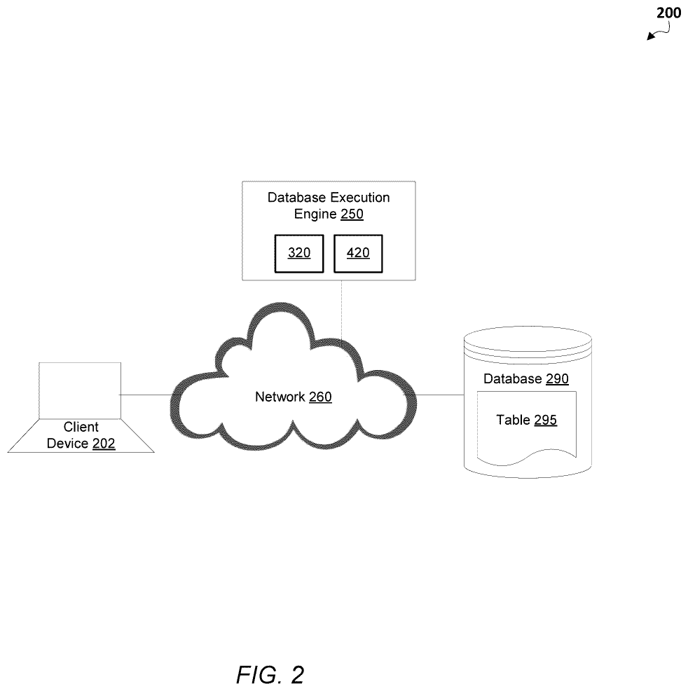

Turning now to FIG. 2, a system diagram illustrating an example of a database system 200 is shown, in accordance with one or more embodiments of the current subject matter. Referring to FIG. 2, the database system 200 may include one or more client devices 202, a database execution engine 250, and one or more databases 290. As shown in FIG. 2, the one or more client devices 202, the database execution engine 250, and the one or more databases 290 may be communicatively coupled via a network 260. The one or more databases 290 may include a variety of relational databases including, for example, an in-memory database, a column-based database, a row-based database, and/or the like. The database execution engine 250 may store a database table 295 at the one or more databases 290, with the database table 295 representative of any number and type of tables.

In some example embodiments, the one or more databases 290 may include a relational database. However, it should be appreciated that the one or more databases 290 may include any type of database including, for example, an in-memory database, a hierarchical database, an object database, an object-relational database, and/or the like. For example, instead of and/or in addition to including a relational database, the one or more databases 290 may include a graph database, a column store, a key-value store, a document store, and/or the like.

The one or more client devices 202 may include processor-based devices including, for example, a mobile device, a wearable apparatus, a personal computer, a workstation, an Internet-of-Things (IoT) appliance, and/or the like. The network 260 may be a wired network and/or wireless network including, for example, a public land mobile network (PLMN), a local area network (LAN), a virtual local area network (VLAN), a wide area network (WAN), the Internet, and/or the like.

To illustrate by way of an example, a given client device 202 may send a query via the database execution engine 250 to the database layer including the one or more databases 290, which may represent a persistence and/or storage layer where database tables may be stored and/or queried. Furthermore, the database execution engine 250 may provide the ability to access table storage via an abstract interface to a table adapter, which may reduce dependencies on specific types of storage and persistence layers, which may in turn enable use with different types of storage and persistence layers.

The database execution engine 250 may be configured to handle different types of databases and the corresponding persistent layers and/or tables therein. The database execution engine 250 may perform operations including rule-based operations, such as joins and projections, as well as filtering, group by, multidimensional analysis, and/or the like in such a manner so as to reduce the processing burden on the database layer. In this way, the database execution engine 250 may execute these and other complex operations, while the one or more databases 290 can perform simpler operations to reduce the processing burden at the one or more databases 290.

In an example, database execution engine 250 includes parser 320 and control unit 420 for dynamically determining an order of execution for the setup programs responsible for configuring an ERP system. In another example, parser 320 and control unit 420 are implemented separately from database execution engine 250. For example, in another embodiment, parser 320 and control unit 420 are implemented as part of a start-up engine. In a further embodiment, parser 320 and control unit 420 are implemented as operating system (OS) components. Other ways of implementing parser 320 and control unit 420 are possible and are contemplated. More details on the operation of parser 320 and control unit 420 will be provided throughout the remainder of this disclosure.

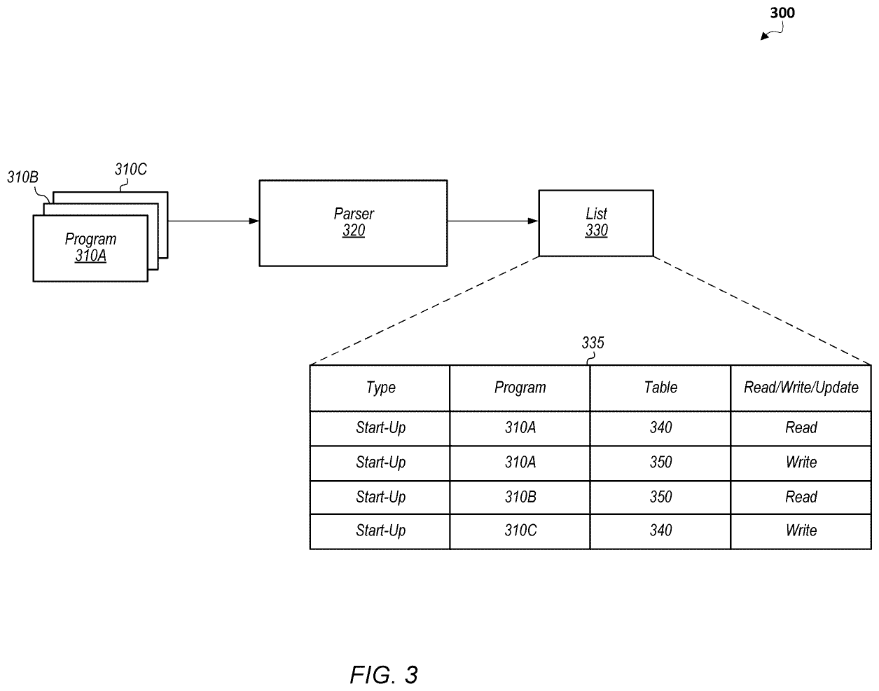

Referring now to FIG. 3, a block diagram of a parser 320 is shown, in accordance with one or more embodiments of the current subject matter. In an example, programs 310A-C are provided as inputs to a parser 320. In other examples, other numbers of programs may be provided as inputs to parser 320. It is noted that parser 320 may be referred to herein as a parsing engine, a parsing unit, or a parsing tool.

When programs 310A-C are provided as inputs to parser 320, parser 320 determines the database tables that are written to and read by programs 310A-C. Parser 320 may use any suitable technique for parsing the source code of programs 310A-C. Parser 320 may generate list 330 as an output, with list 330 specifying the database tables that are written to and/or read by programs 310A-C. In other words, read and write accesses in programs 310A-C are identified by parser 320, and a tabulation of these read and write accesses is generated and output by parser 320 as list 330. In an example, parser 320 searches programs 310A-C for select, update or insert calls to identify the read and write accesses of programs 310A-C. It should be understood that depending on the embodiment, any number of programs may be provided as inputs to parser 320, and parser 320 may generate, as an output, a list of all read and write accesses detected in the plurality of programs. It is also noted that parser 320 may be implemented using any suitable combination of hardware (e.g., circuitry, one or more processing units) and/or software (e.g., program instructions.

An expanded view 335 of list 330 is shown below list 330. Expanded view 335 is merely intended to represent one particular example of list 330. In other embodiments, list 330 may be structured in other suitable fashions. As shown in expanded view 335, parser 320 has identified program 310A as reading from table 340, parser 320 has identified program 310A as writing to table 350, parser 320 has identified program 310B as reading from table 350, and parser 320 has identified program 310A as writing to table 340. It should be understood that these database reads and writes are merely representative of one example embodiment. In other embodiments, parser 320 may identify other numbers of database access calls from a list of start-up programs. For example, in other embodiments, parser 320 may identify hundreds or thousands of database access calls from a list of start-up programs. Accordingly, expanded view 335 is meant to serve as a relatively simple example to illustrate the dynamic ordering determination techniques presented herein.

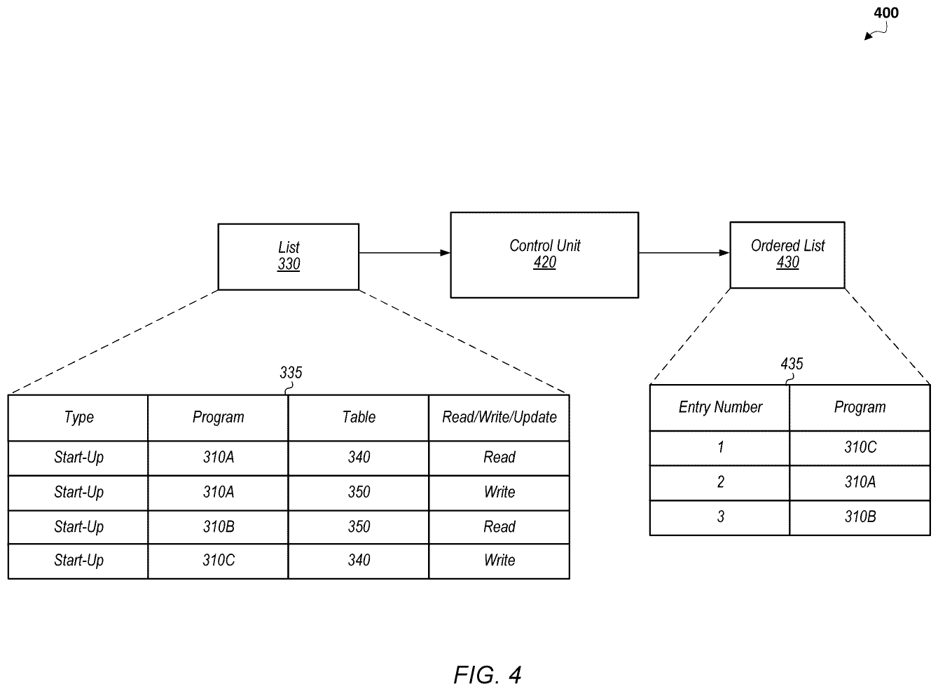

Turning now to FIG. 4, a block diagram of an example of a control unit 420 for generating an ordered list 430 is shown, in accordance with one or more embodiments of the current subject matter. It is noted that ordered list 430 may also be referred to as an ordered table or as a table. In an example, control unit 420 receives list 330 which is generated by a parser (e.g., parser 320 of FIG. 3). Expanded view 335 is shown below list 330, which includes the same entries as shown in FIG. 3. Control unit 420 first searches list 330 for programs which do not read from any tables written to by other programs in list 330. In this example, only program 310C does not read from any tables written to by other programs in list 330. Accordingly, control unit 420 adds program 310C as the first entry of ordered list 430 as shown in expanded view 435.

Next, control unit 420 searches list 330 for any programs which only read data from programs in ordered list 430. At this particular point in time, only program 310C has been inserted into list 430, and program 310C writes to table 340. Therefore, control unit 420 identifies program 310A as only reading from table 340. Then, as a result of this identification, control unit 420 adds program 310A as the second entry of ordered list 430. Finally, control unit 420 determines if there are any programs in list 330 that only read from the first and second entries of ordered list 430. In this case, program 310B reads from table 350, which is written to by program 310A. Since program 310A has been added as the second entry of ordered list 430, it is now safe for control unit 420 to add program 310B as the third entry of ordered list 430. At this point in time, since all programs from list 330 have been added to ordered list 430, ordered list 430 may be finalized and used as the order for launching programs during start-up of the system. It is noted that other embodiments with other numbers of programs may follow a similar process as outlined in FIG. 4 for generating an ordered list of programs for starting up the system. It is also noted that control unit 420 may be implemented using any suitable combination of hardware (e.g., circuitry, one or more processing units) and/or software (e.g., program instructions).

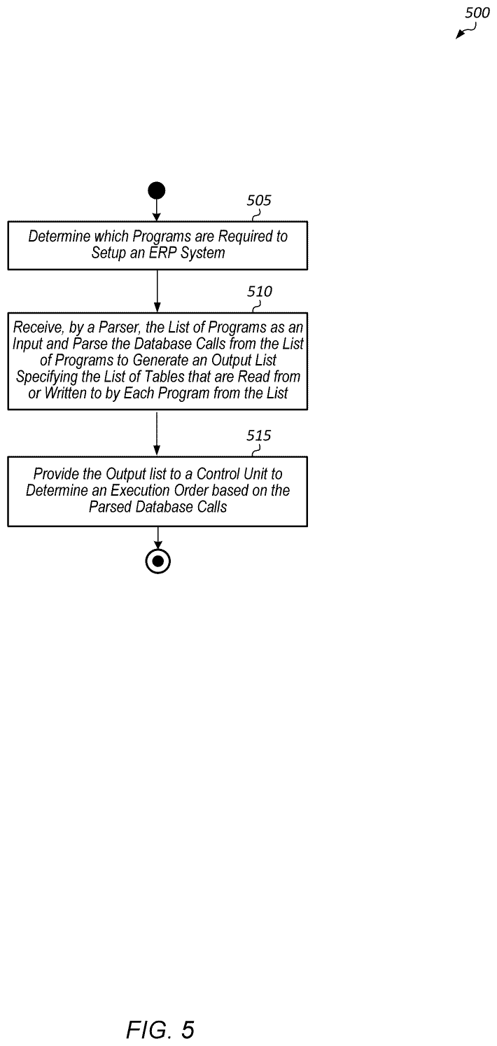

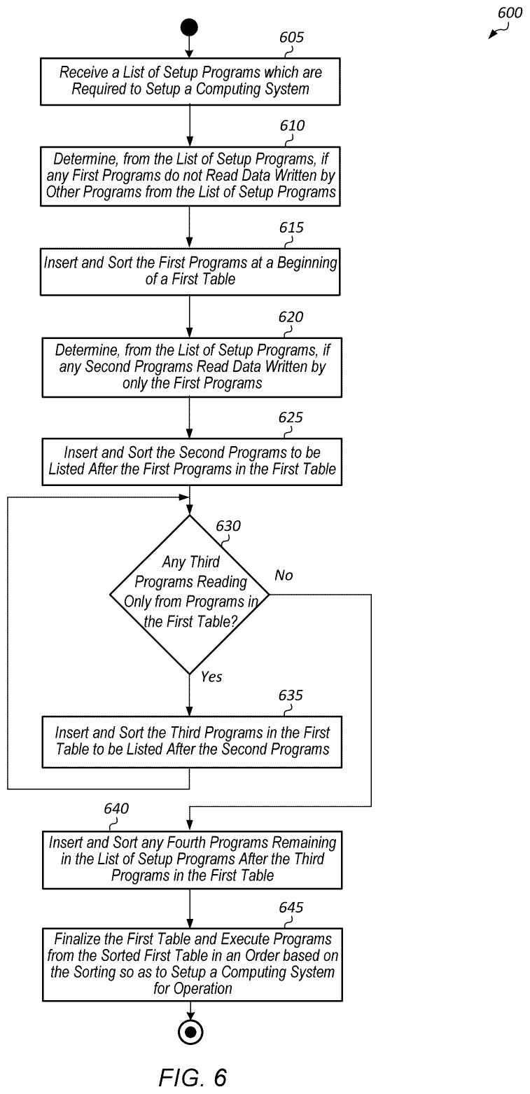

Referring now to FIG. 5, a process for parsing a list of setup programs is depicted, in accordance with one or more embodiments of the current subject matter. An ERP vendor determines which programs are required to setup the ERP system (block 505). Next, a parser receives the list of programs (determined by the ERP vendor) as an input and parses the database calls from the list of programs to generate an output list specifying the list of tables that are read from or written to by each program from the list (block 510). Then, the output list is provided to a control unit to determine an execution order based on the parsed database calls (block 515). After block 515, method 500 may end. One example of a method for implementing block 515 is described below in the discussion associated with method 600 (of FIG. 6).

Turning now to FIG. 6, a process for determining an order to launch setup programs is depicted, in accordance with one or more embodiments of the current subject matter. A control unit receives a list of setup programs which are required to be launched in order to setup a computing system (block 605). In an example, the list of setup programs is generated by a parser and the list specifies which tables are read from and written to by each program in the list. In an example, the control unit is part of an ERP system. In other examples, the control unit may be part of any of various other types of systems (e.g., database system, cloud system). Next, the control unit determines, from the list of setup programs, if any first programs do not read data written by other programs from the list of setup programs (block 610). For example, the first programs are programs that only write to tables, or the first programs are programs that only read from tables that are not written to by other programs from the list of setup programs. Then, the control unit inserts and sorts the first programs at a beginning of a first table (block 615). It is noted that the first programs may be deleted or marked as invalid in the list of setup programs to indicate that they have been added to the first table.

Next, the computing system determines from the list of setup programs, if any second programs read data written by only the first programs (block 620). It is noted that in block 620, the second programs identified by the control unit are those programs which read data written by the first programs (which have already been added to the first table) but do not read data written by any other programs remaining in the list of setup programs (i.e., those programs not yet added to the first table). Then, the computing system inserts and sorts the second programs to be listed after the first programs in the first table (block 625). The second programs may be deleted or marked as invalid in the list of setup programs to indicate that they have been added to the first table.

Next, the computing system determines if there are any third programs that only read data written by the first and second programs already added to the first table (conditional block 630). In other words, the third programs are those programs that only read data written by programs that are in the first table. If there are any third programs in the list of programs that only read data written by the first and second programs already added to the first table (conditional block 630, “yes” leg), then the control unit inserts and sorts the third programs in the first table to be listed after the second programs (block 635). Similar to the earlier added programs, the third programs may be deleted or marked as invalid in the list of setup programs to indicate that they have been added to the first table. After block 635, method 600 returns to conditional block 630. It is noted that conditional block 630 and block 635 may be repeated any number of times as long as there are still programs remaining in the list of setup programs that only read data written by those programs that have already been added to the first table.

Otherwise, if there are no more programs in the list of programs that only read data written by the those programs already added to the first table (conditional block 630, “no” leg), then the control unit sorts any fourth programs remaining in the list of setup programs after the third programs in the first table (block 640). Then, the first table is finalized and the control unit causes programs from the sorted first table to be executed in an order based on the sorting so as to setup a computing system for operation (block 645). In other words, the first programs are executed first, followed by the second programs, followed by the third programs, and then followed by the fourth programs. After block 645, method 600 may end.

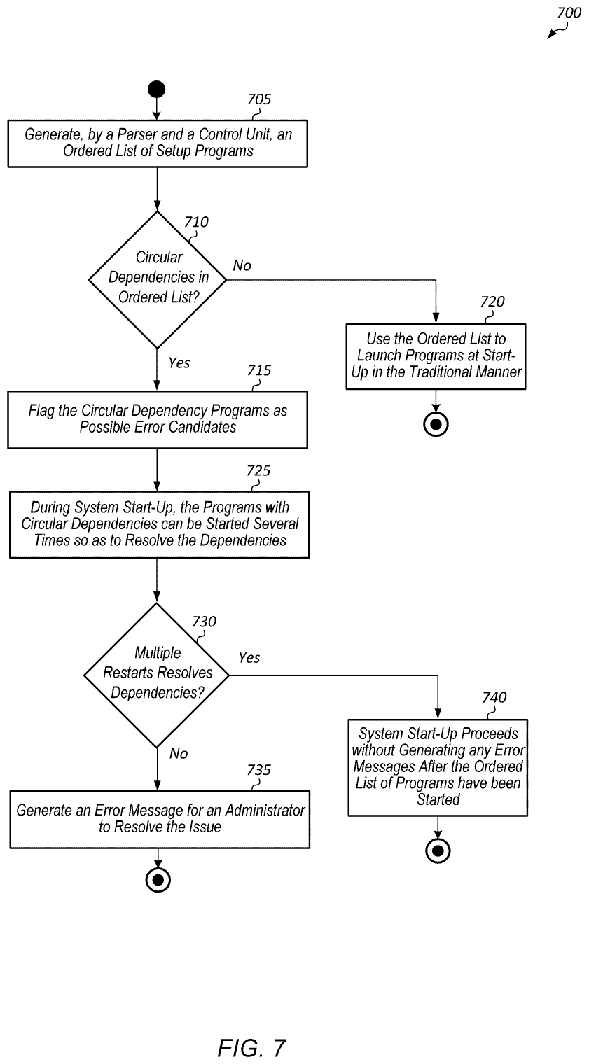

Referring now to FIG. 7, a process for executing a list of programs at system startup when one or more programs have circular dependencies is depicted, in accordance with one or more embodiments of the current subject matter. An ordered list of setup programs (i.e., setup tasks) is generated based on a parser (e.g., parser 320 of FIG. 4) and a control unit (e.g., control unit 420 of FIG. 4) (block 705). One example of generating an ordered list of setup programs is described in method 600 (of FIG. 6). In other embodiments, other methods for generating an ordered list of setup programs may be employed. However, in some cases, there may be programs which cannot be ordered due to circular dependencies. If the ordered list includes programs which cannot be ordered due to circular dependencies (conditional block 710, “yes” leg), then the control unit may flag these programs as possible error candidates (block 715). If the ordered list does not include any programs with circular dependencies (conditional block 710, “no” leg), then the ordered list may be used to launch programs at start-up in the traditional manner (block 720). After block 720, method 700 may end.

After block 715, during system start-up, the programs with circular dependencies can be started several times so as to resolve the dependencies (block 725). If the dependencies cannot be resolved by starting these programs multiple times (conditional block 730, “no” leg), then an error message may be generated for an administrator to resolve the issue (block 735). Otherwise, if the dependencies are resolved by starting these programs multiple times (conditional block 730, “yes” leg), then system start-up may proceed without generating any error messages after the ordered list of programs have been started (block 740). After blocks 735 and 740, method 700 may end.

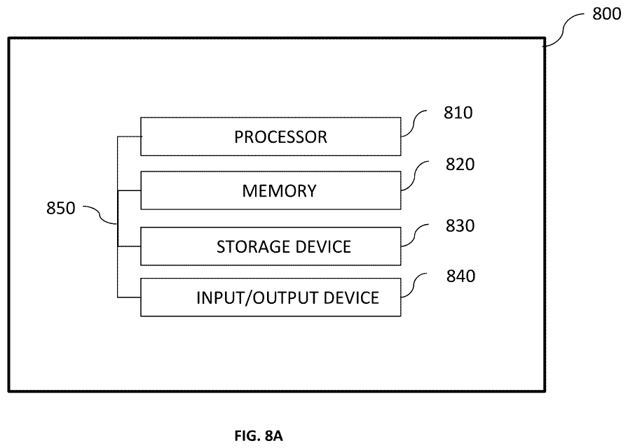

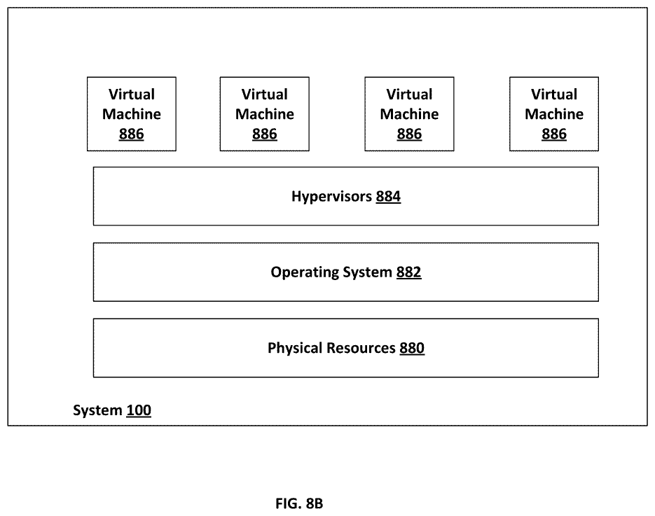

In some implementations, the current subject matter may be configured to be implemented in a system 800, as shown in FIG. 8A. The system 800 may include a processor 810, a memory 820, a storage device 830, and an input/output device 840. Each of the components (e.g., the processor 810, the memory 820, the storage device 830, the I/O device 840) may be interconnected using a system bus 850. The processor 810 may be configured to process instructions for execution within the system 800. In some implementations, the processor 810 may be a single-threaded processor. In alternate implementations, the processor 810 may be a multi-threaded processor. The processor 810 may be further configured to process instructions stored in the memory 820 or on the storage device 830, including receiving or sending information through the input/output device 840. The memory 820 may store information within the system 800. In some implementations, the memory 820 may be a computer-readable medium. In alternate implementations, the memory 820 may be a volatile memory unit. In yet some implementations, the memory 820 may be a non-volatile memory unit. The storage device 830 may be capable of providing mass storage for the system 800. In some implementations, the storage device 830 may be a computer-readable medium. In alternate implementations, the storage device 830 may be a floppy disk device, a hard disk device, an optical disk device, a tape device, non-volatile solid state memory, or any other type of storage device. The input/output device 840 may be configured to provide input/output operations for the system 800. In some implementations, the input/output device 840 may include a keyboard and/or pointing device. In alternate implementations, the input/output device 840 may include a display unit for displaying graphical user interfaces.

FIG. 8B depicts an example implementation of the system 100 (of FIG. 1). The system 100 may be implemented using various physical resources 880, such as at least one or more hardware servers, at least one storage, at least one memory, at least one network interface, and the like. The system 100 may also be implemented using infrastructure, as noted above, which may include at least one operating system 882 for the physical resources 880 and at least one hypervisor 884 (which may create and run at least one virtual machine 886). For example, each multitenant application may be run on a corresponding virtual machine 886.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable storage medium” refers to any computer program product, apparatus and/or device, such as for example magnetic discs, optical disks, memory, and Programmable Logic Devices (PLDs), used to provide machine instructions and/or data to a programmable processor, including a machine-readable storage medium that receives program instructions as a machine-readable signal. The term “machine-readable signal” refers to any signal used to provide machine instructions and/or data to a programmable processor. The machine-readable storage medium can store such program instructions non-transitorily, such as for example as would a non-transient solid state memory or a magnetic hard drive or any equivalent storage medium. The machine-readable storage medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B; ” “one or more of A and B; ” and “A and/or B” are each intended to mean “A alone, B alone, or A and B together. ” A similar interpretation is also intended for lists including three or more items. For example, the phrases “at least one of A, B, and C; ” “one or more of A, B, and C; ” and “A, B, and/or C” are each intended to mean “A alone, B alone, C alone, A and B together, A and C together, B and C together, or A and B and C together. ” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system comprising: at least one processor; and at least one memory storing instructions that, when executed by the at least one processor, cause operations comprising: parsing database calls from a first list of programs to generate a second list of programs specifying tables that are read from or written to by each program from the first list; determining, from the second list of programs, if any first programs do not read data written by other programs from the second list of programs; inserting the first programs at a beginning of a first table; determining, from the second list of programs, if any second programs only read data written by the first programs; inserting the second programs after the first programs in the first table; determining, from the second list of programs, if any third programs only read data written by the second programs; inserting the third programs after the second programs in the first table; inserting any fourth programs remaining in the second list of programs after the third programs in the first table; and executing programs from the first table in an order based on the inserting so as to setup a computing system for operation.

Example 2: The system of Example 1, wherein the first programs are first to be executed from the first table, wherein the second programs are to be executed after the first programs, wherein the third programs are to be executed after the second programs, and wherein the fourth programs are to be executed after the third programs.

Example 3: The system of any of Examples 1-2, wherein programs are removed from the second list of programs after being inserted in the first table.

Example 4: The system of any of Examples 1-3, wherein programs are marked as being invalid in the second list of programs after being inserted in the first table.

Example 5: The system of any of Examples 1-4, wherein the first table is an ordered table.

Example 6: The system of any of Examples 1-5, wherein the operations further comprise identifying and marking, in the first table, one or more fifth programs as having circular dependencies.

Example 7: The system of any of Examples 1-6, wherein the operations further comprise restarting the one or more fifth programs multiple times until the circular dependencies are resolved.

Example 8: The system of any of Examples 1-7, wherein the one or more fifth programs are executed after the fourth programs.

Example 9: The system of any of Examples 1-8, wherein the first list of programs includes a plurality of setup tasks that are required to launch the computing system.

Example 10: The system of any of Examples 1-9, wherein the computing system is an enterprise resource planning (ERP) system.

Example 11: A computer-implemented method comprising: parsing database calls from a first list of programs to generate a second list of programs specifying tables that are read from or written to by each program from the first list; determining, from the second list of programs, if any first programs do not read data written by other programs from the second list of programs; inserting the first programs at a beginning of a first table; determining, from the second list of programs, if any second programs only read data written by the first programs; inserting the second programs after the first programs in the first table; determining, from the second list of programs, if any third programs only read data written by the second programs; inserting the third programs after the second programs in the first table; inserting any fourth programs remaining in the second list of programs after the third programs in the first table; and executing programs from the first table in an order based on the inserting so as to setup a computing system for operation.

Example 12: The computer-implemented method of Example 11, wherein the first programs are first to be executed from the first table, wherein the second programs are to be executed after the first programs, wherein the third programs are to be executed after the second programs, and wherein the fourth programs are to be executed after the third programs.

Example 13: The computer-implemented method of any of Examples 11-12, wherein programs are removed from the second list of programs after being inserted in the first table.

Example 14: The computer-implemented method of any of Examples 11-13, wherein programs are marked as being invalid in the second list of programs after being inserted in the first table.

Example 15: The computer-implemented method of any of Examples 11-14, wherein the first table is an ordered table.

Example 16: The computer-implemented method of any of Examples 11-15, further comprising identifying and marking, in the first table, one or more fifth programs as having circular dependencies.

Example 17: The computer-implemented method of any of Examples 11-16, further comprising restarting the one or more fifth programs multiple times until the circular dependencies are resolved.

Example 18: The computer-implemented method of any of Examples 11-17, wherein the one or more fifth programs are executed after the fourth programs.

Example 19: The computer-implemented method of any of Examples 11-18, wherein the first list of programs includes a plurality of setup tasks that are required to launch the computing system.

Example 20: A non-transitory computer readable storage medium storing instructions, which when executed by at least one data processor, result in operations comprising: parsing database calls from a first list of programs to generate a second list of programs specifying tables that are read from or written to by each program from the first list; determining, from the second list of programs, if any first programs do not read data written by other programs from the second list of programs; inserting the first programs at a beginning of a first table; determining, from the second list of programs, if any second programs only read data written by the first programs; inserting the second programs after the first programs in the first table; determining, from the second list of programs, if any third programs only read data written by the second programs; inserting the third programs after the second programs in the first table; inserting any fourth programs remaining in the second list of programs after the third programs in the first table; and executing programs from the first table in an order based on the inserting so as to setup a computing system for operation.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A system comprising:
at least one processor; and
at least one memory storing instructions that, when executed by the at least one processor, cause operations comprising:
parsing database calls from a first list of programs to generate a second list of programs specifying tables that are read from or written to by each program from the first list;
determining, from the second list of programs, if any first programs do not read data written by other programs from the second list of programs;
inserting the first programs at a beginning of a first table;
determining, from the second list of programs, if any second programs only read data written by the first programs;
inserting the second programs after the first programs in the first table;
determining, from the second list of programs, if any third programs only read data written by the second programs;
inserting the third programs after the second programs in the first table;
inserting any fourth programs remaining in the second list of programs after the third programs in the first table; and
executing programs from the first table in an order based on the inserting so as to setup a computing system for operation.

2. The system of claim 1, wherein the first programs are first to be executed from the first table, wherein the second programs are to be executed after the first programs, wherein the third programs are to be executed after the second programs, and wherein the fourth programs are to be executed after the third programs.

3. The system of claim 2, wherein programs are removed from the second list of programs after being inserted in the first table.

4. The system of claim 2, wherein programs are marked as being invalid in the second list of programs after being inserted in the first table.

5. The system of claim 2, wherein the first table is an ordered table.

6. The system of claim 2, wherein the operations further comprise identifying and marking, in the first table, one or more fifth programs as having circular dependencies.

7. The system of claim 6, wherein the operations further comprise restarting the one or more fifth programs multiple times until the circular dependencies are resolved.

8. The system of claim 7, wherein the one or more fifth programs are executed after the fourth programs.

9. The system of claim 1, wherein the first list of programs includes a plurality of setup tasks that are required to launch the computing system.

10. The system of claim 1, wherein the computing system is an enterprise resource planning (ERP) system.

11. A computer-implemented method comprising:
parsing database calls from a first list of programs to generate a second list of programs specifying tables that are read from or written to by each program from the first list;
determining, from the second list of programs, if any first programs do not read data written by other programs from the second list of programs;
inserting the first programs at a beginning of a first table;
determining, from the second list of programs, if any second programs only read data written by the first programs;
inserting the second programs after the first programs in the first table;
determining, from the second list of programs, if any third programs only read data written by the second programs;
inserting the third programs after the second programs in the first table;
inserting any fourth programs remaining in the second list of programs after the third programs in the first table; and
executing programs from the first table in an order based on the inserting so as to setup a computing system for operation.

12. The computer-implemented method of claim 11, wherein the first programs are first to be executed from the first table, wherein the second programs are to be executed after the first programs, wherein the third programs are to be executed after the second programs, and wherein the fourth programs are to be executed after the third programs.

13. The computer-implemented method of claim 12, wherein programs are removed from the second list of programs after being inserted in the first table.

14. The computer-implemented method of claim 12, wherein programs are marked as being invalid in the second list of programs after being inserted in the first table.

15. The computer-implemented method of claim 12, wherein the first table is an ordered table.

16. The computer-implemented method of claim 12, further comprising identifying and marking, in the first table, one or more fifth programs as having circular dependencies.

17. The computer-implemented method of claim 16, further comprising restarting the one or more fifth programs multiple times until the circular dependencies are resolved.

18. The computer-implemented method of claim 17, wherein the one or more fifth programs are executed after the fourth programs.

19. The computer-implemented method of claim 11, wherein the first list of programs includes a plurality of setup tasks that are required to launch the computing system.

20. A non-transitory computer readable storage medium storing instructions, which when executed by at least one data processor, result in operations comprising:
parsing database calls from a first list of programs to generate a second list of programs specifying tables that are read from or written to by each program from the first list;
determining, from the second list of programs, if any first programs do not read data written by other programs from the second list of programs;
inserting the first programs at a beginning of a first table;
determining, from the second list of programs, if any second programs only read data written by the first programs;
inserting the second programs after the first programs in the first table;
determining, from the second list of programs, if any third programs only read data written by the second programs;
inserting the third programs after the second programs in the first table;
inserting any fourth programs remaining in the second list of programs after the third programs in the first table; and
executing programs from the first table in an order based on the inserting so as to setup a computing system for operation.
